(19) United States
(12) Patent Application Publication
(10) Pub. No.: US 2026/0126306 A1
(43) Pub. Date: May 7, 2026

(54) MAGNETIC ENCODER

(71) Applicant: Mitsubishi Electric Corporation, Tokyo (JP)

(72) Inventors: Akira HOTTA, Tokyo (JP); Takeshi MUSHA, Tokyo (JP)

(73) Assignee: Mitsubishi Electric Corporation, Tokyo (JP)

(21) Appl. No.: 19/118,749

(22) PCT Filed: Oct. 11, 2022
(86) PCT No.: PCT/JP2022/037887

§ 371 Date: Apr. 4, 2025

(51) Int. Cl. G01D 5/245

(52) U.S. Cl. CPC G01D 5/245

(57) ABSTRACT

A magnetic encoder includes a magnetic scale unit including a magnet and a magnet disposed side by side in a first direction and having magnetization directions opposite to each other, and a magnetic body spaced from the magnet along the magnetization direction of the magnet. The magnetic encoder includes a position detection unit including a magnetic detection element spaced from each of the magnet and the magnetic body. The magnetic body has a length corresponding to one wavelength of a wavelength determined based on resolution, and the magnetic body has a curved surface facing the magnet, the curved surface being most convex at positions of the magnetic body corresponding to 1/4 and 3/4 of the wavelength from an end portion of the magnetic body, and each magnet is disposed at a position facing a position where the facing surface of the magnetic body is the most convex.

### FIELD

The present disclosure relates to a magnetic encoder having a magnetic detection unit and a position detection unit that relatively move.

### BACKGROUND

Magnetic encoders include a magnetic detection unit and a position detection unit that move relative to each other. Such a magnetic encoder is used for, for example, a rotary encoder that is a rotation detector for controlling a rotary servomotor, and a linear encoder that is a position detector for controlling a linear motor.

Patent Literature 1 discloses a magnetic scale unit having a plurality of magnetic poles. The magnetic scale unit has a magnetic pole array having a plurality of magnetic poles of the same polarities arranged at equal intervals. The interval between the magnetic poles is larger than the width in the direction of the arrangement of the magnetic poles and smaller than twice the width in the arrangement direction of the magnetic poles. A magnetic sensor outputs a magnetic field change in the magnetic scale unit as an electric signal, and position information is acquired from a peak of the voltage.

### CITATION LIST

### Patent Literature

Patent Literature 1: Japanese Patent Application Laid-open No. 2001-227904

### SUMMARY OF INVENTION

### Problem to be solved by the Invention

Since the widths of the plurality of magnets having the same polarity in Patent Literature 1 are all the same, there is a problem of obtaining only the peak position of the magnetic field and discrete position information corresponding to the peak position.

The present disclosure has been made in view of the above, and an object thereof is to obtain a magnetic encoder capable of obtaining a smooth long-period sine wave signal and acquiring continuous and highly accurate position information in a wide range.

### Means to Solve the Problem

In order to solve the above-described problems and achieve the object, a magnetic encoder according to the present disclosure is a magnetic encoder including a magnetic scale unit and a position detection unit, the magnetic scale unit and the position detection unit moving relative to each other along a first direction, wherein the magnetic scale unit includes: a first magnetic field generation source and a second magnetic field generation source disposed side by side in the first direction and having magnetization directions opposite to each other; a magnetic body disposed with an interval away from the first magnetic field generation source and the second magnetic field generation source along a magnetization direction of the first magnetic field generation source and the second magnetic field generation source; and a base body to position the first magnetic field generation source, the second magnetic field generation source, and the magnetic body. The position detection unit includes: a magnetic detection element disposed in a region between the magnetic body and each of the first magnetic field generation source and the second magnetic field generation source with an interval between the magnetic detection element and each of the first magnetic field generation source, the second magnetic field generation source, and the magnetic body, and to output a change in magnetic field as an electric signal, the magnetic body has a length in the first direction, the length being a length corresponding to one wavelength of a wavelength determined on a basis of resolution of position detection of the magnetic scale unit in the first direction, and the magnetic body has a curved surface facing the first magnetic field generation source and the second magnetic field generation source, the magnetic body having an end portion in the first direction and positions corresponding to ¼ and ¾ of the wavelength from the end portion in the first direction, the curved surface being most convex at the positions corresponding to ¼ and ¾ of the wavelength, and the first magnetic field generation source is disposed at a position facing the position corresponding to ¼ of the wavelength, and the second magnetic field generation source is disposed at a position facing the position corresponding to ¾ of the wavelength.

### Effects of the Invention

The magnetic encoder of the present disclosure can achieve the effect of obtaining the smooth long-period sine wave signal, and acquiring the continuous and highly accurate position information in the wide range.

### BRIEF DESCRIPTION OF DRAWINGS

FIG. 1 is a perspective view illustrating a magnetic encoder according to the first embodiment.

FIG. 2 is a front view illustrating a magnetic encoder according to the first embodiment.

FIG. 3 is a front view illustrating a magnetic encoder according to a comparative example of the first embodiment.

FIG. 4 is a diagram illustrating a flow of magnetic flux in the magnetic encoder according to the comparative example of the first embodiment.

FIG. 5 is a diagram illustrating a waveform of the intensity of the magnetic field applied to the magnetic detection element by the magnetic scale unit of the magnetic encoder according to the comparative example of the first embodiment.

FIG. 6 is a diagram illustrating a flow of magnetic flux in the magnetic encoder according to the first embodiment.

FIG. 7 is a diagram illustrating a waveform of the intensity of the magnetic field applied to the magnetic detection element by the magnetic scale unit of the magnetic encoder according to the first embodiment.

FIG. 8 is a diagram illustrating a waveform of the intensity of the magnetic field applied to the magnetic detection element by the magnetic scale unit when the distance between the magnetic scale and the magnetic detection element of the magnetic encoder according to the comparative example of the first embodiment fluctuates.

FIG. 9 is a diagram illustrating a waveform of the intensity of the magnetic field applied to the magnetic detection element by the magnetic scale unit when the distance between the magnetic scale and the magnetic detection element of the magnetic encoder according to the first embodiment fluctuates.

FIG. 10 is a front view illustrating a magnetic encoder according to the second embodiment.

FIG. 11 is a diagram illustrating directions of internal magnetization of magnet groups in the magnetic encoder according to the second embodiment.

FIG. 12 is a diagram illustrating a waveform of the intensity of the magnetic field applied to the magnetic detection element by the magnetic scale unit of the magnetic encoder according to the second embodiment.

FIG. 13 is a front view illustrating a magnetic encoder according to the third embodiment.

FIG. 14 is a diagram illustrating directions of internal magnetization of magnet groups in the magnetic encoder according to the third embodiment.

FIG. 15 is a perspective view illustrating a configuration of a magnetic encoder according to the fourth embodiment.

FIG. 16 is a front view illustrating a configuration of a magnetic encoder according to the fourth embodiment.

### DESCRIPTION OF EMBODIMENTS

A magnetic encoder according to an embodiment will be hereinafter described in detail with reference to the drawings.

### First Embodiment

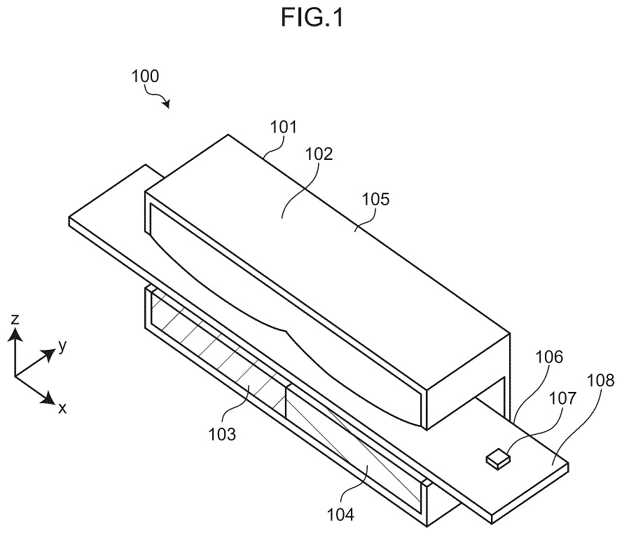

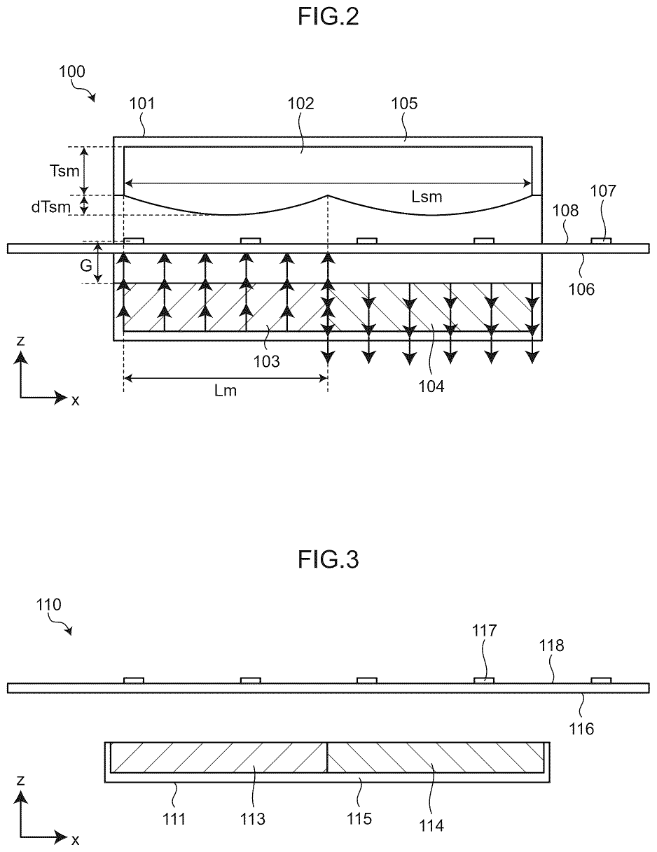

FIG. 1 is a perspective view illustrating a magnetic encoder according to the first embodiment. FIG. 2 is a front view illustrating a magnetic encoder according to the first embodiment. The magnetic encoder 100 of the first embodiment includes a magnetic scale unit 101 and a position detection unit 106. The position detection unit 106 detects a magnetic field generated by the magnetic scale unit 101. The magnetic encoder 100 according to the first embodiment is a linear encoder. The magnetic scale unit 101 includes a magnet 103 defined as a first magnetic field generation source, and a magnet 104 defined as a second magnetic field generation source. The magnetic scale unit 101 further includes a magnetic body 102 and a base body 105. The magnetic body 102 is disposed an interval away from each of the magnet 103 and the magnet 104 in the magnetization direction of the magnet 103 and the magnet 104. The base body 105, which is non-magnetic, fixes each of the magnet 103 and the magnet 104 and the magnetic body 102. In the magnetic encoder 100 according to the first embodiment, the base body 105 may be made of resin. The position detection unit 106 includes a plurality of magnetic detection elements 107 and a substrate 108. The magnetic detection elements 107 detect a magnetic field generated from the magnetic scale unit 101. The substrate 108 has the magnetic detection elements 107 attached thereto.

FIGS. 1 and 2 illustrate the magnetic encoder 100 in an xyz-three-dimensional orthogonal coordinate system. The x direction corresponds to the moving direction of the magnetic scale unit 101. The z direction corresponds to a direction in which the magnetic scale unit 101 and the position detection unit 106 face each other. The y direction is a direction perpendicular to the x direction and the z direction. In the present disclosure, in the case of the linear encoder, the x direction corresponds to the first direction.

In FIG. 2, Tsm indicates the minimum length of the magnetic body 102 in the z direction. Lsm indicates the length of the magnetic body 102 in the x direction. Lm indicates a magnet width which is the length of each of the magnet 103 and the magnet 104 in the x direction. G indicates a distance from the surface of each of the magnet 103 and the magnet 104 to the sensitive surface of the magnetic detection element 107. For a length dTsm in the z direction of the convex portion of the magnetic body 102, dTsm>Lsm/50 is defined as holding true. The length Lsm of the magnetic body 102 in the x direction is twice the magnet width Lm of each of the magnet 103 and the magnet 104. Note that Lsm of the magnetic body 102, which is a length in the x direction defined as the first direction, is a length corresponding to one wavelength of a wavelength determined on the basis of the resolution of position detection of the magnetic scale unit 101 in the x direction.

The magnetic body 102 has convexly curved surfaces facing and protruding toward the magnet 103 and the magnet 104. The magnetic body 102 has opposite end portions and a center in the x direction. The opposite end portion and the center provide the maximum intervals between the magnetic body 102 and each of the magnet 103 and the magnet 104. In addition, the magnetic body 102 has a position located ¼ times the length Lsm of the magnetic body 102 away from the end portion of the magnetic body 102 in the x direction, and a position located ¾ times Lsm away from the end portion of the magnetic body 102 in the x direction. These positions away from the end portion provide the minimum intervals between the magnetic body 102 and each of the magnet 103 and the magnet 104.

The magnetic scale unit 101 and the position detection unit 106 move relative to each other. In the first embodiment, the magnetic scale unit 101 is a mover that moves in the x direction. The position detection unit 106 is a stator fixed at a certain distance from the magnetic scale unit 101 in the z direction. The position detection unit 106 detects the position of the magnetic scale unit 101 from a magnetic field change at the time the magnetic scale unit 101 moves past the position detection unit 106.

The substrate 108 has a band shape having a surface extending in parallel to the xy plane, and the x direction is a longitudinal direction. As illustrated in FIG. 2, the plurality of magnetic detection elements 107 are disposed on the substrate 108 at equal pitches in the x direction. A pitch at which the magnetic detection elements 107 are disposed is set to a pitch equal to or less than a sine wave wavelength formed by the magnetic scale unit 101 so as not to provide a region in which the detection of the position of the magnetic scale unit 101 fails. The magnetic detection element 107 is disposed in a region between the magnetic body 102 and each of the magnet 103 and the magnet 104 with an interval between the magnetic detection element 107 and each of the magnet 103, the magnet 104, and the magnetic body 102, and outputs a change in magnetic field as an electric signal.

FIG. 3 is a front view illustrating a magnetic encoder according to a comparative example of the first embodiment. In the magnetic encoder 110 according to the comparative example of the first embodiment, the magnetic scale unit 111 does not include a magnetic body, and the base body 115 fixes the magnet 113 and the magnet 114. The position detection unit 116 includes a plurality of magnetic detection elements 117 and a substrate 118. The magnetic detection elements 117 detect a magnetic field generated from the magnetic scale unit 111. The substrate 118 has the magnetic detection elements 117 attached thereto. The substrate 118 has a band shape having a surface extending in parallel to the xy plane, and the x direction is a longitudinal direction. As illustrated in FIG. 3, the plurality of magnetic detection elements 117 of the position detection unit 116 are disposed on the substrate 118 at equal pitches in the x direction.

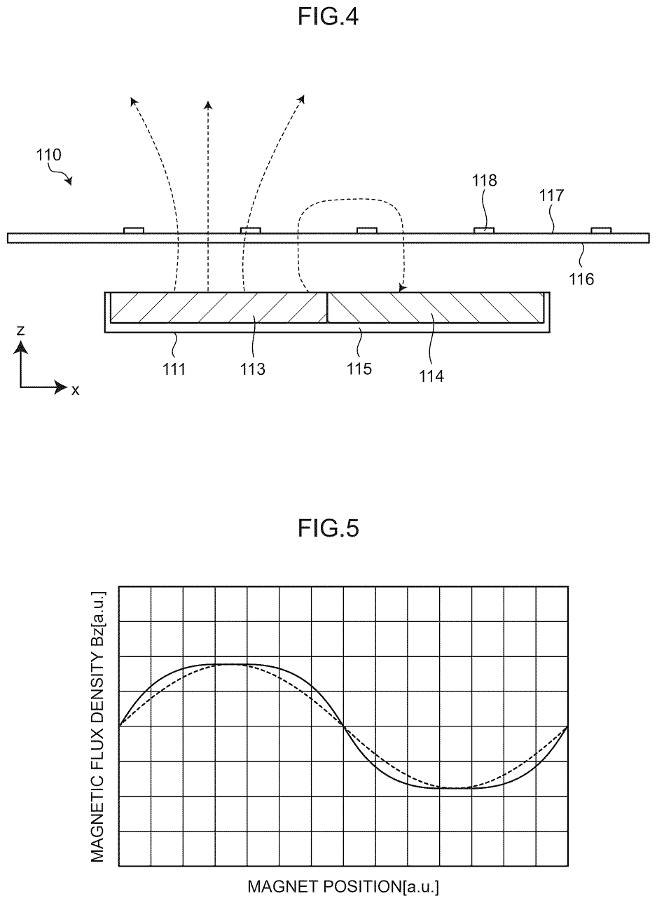

FIG. 4 is a diagram illustrating a flow of magnetic flux in the magnetic encoder according to the comparative example of the first embodiment. In the magnetic encoder 110 according to the comparative example of the first embodiment, for example, most of the magnetic flux emitted from the magnet 113 diverges without returning to the magnet 114, and only a small part of the magnetic flux returns to the magnet 114. For this reason, in the magnetic encoder 110 according to the comparative example, the magnetic flux farther from the surfaces of the magnet 113 and the magnet 114 becomes significantly weaker, and the greater distance G from each of the surfaces of the magnet 113 and the magnet 114 to the sensitive surface of the magnetic detection element 117 provides the smaller amplitude of the intensity of the magnetic field applied to the magnetic detection element 117.

FIG. 5 is a diagram illustrating a waveform of the intensity of the magnetic field applied to the magnetic detection element by the magnetic scale unit of the magnetic encoder according to the comparative example of the first embodiment. The magnetization direction of the magnet 113 is the +z direction, and the magnetization direction of the magnet 114 is the −z direction. In FIG. 5, the vertical axis represents the magnetic flux density Bz, and the horizontal axis represents the position of the magnetic scale unit 111. Note that [a. u.] on the vertical axis and the horizontal axis represents an arbitrary unit. In FIG. 5, a solid line indicates the intensity of the magnetic field applied to the magnetic detection element 117 by the magnetic scale unit 111 of the magnetic encoder 110 according to the comparative example of the first embodiment, and a broken line indicates a sinusoidal waveform which is an ideal waveform. As illustrated in FIG. 5, in the magnetic encoder 110 according to the comparative example, the rising and falling of the magnetic flux density are steeper than the sine wave, and the amplitude approaches the maximum value at a longer section of the magnet position.

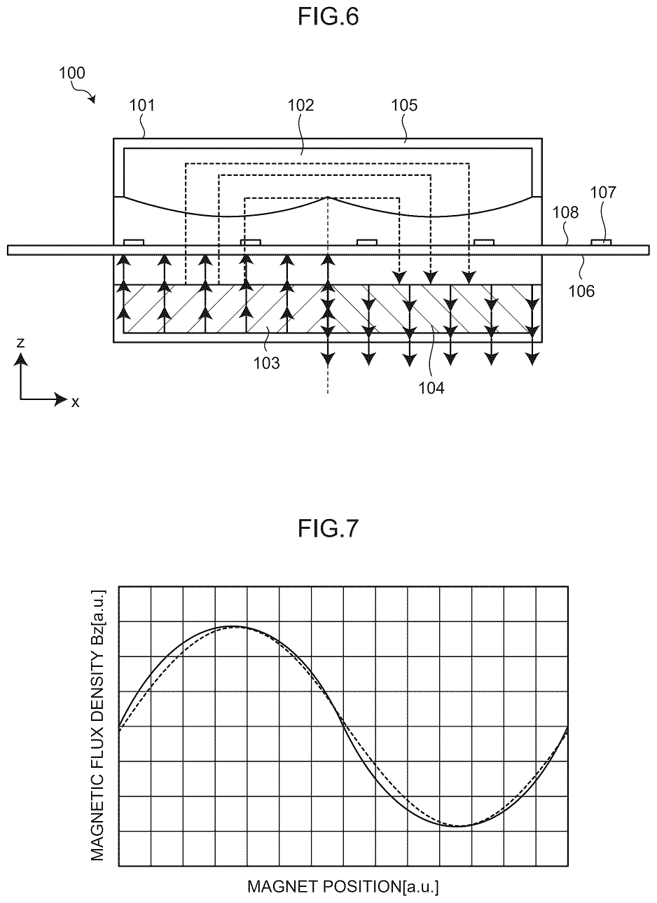

FIG. 6 is a diagram illustrating a flow of magnetic flux in the magnetic encoder according to the first embodiment. In the magnetic encoder 100 according to the first embodiment, for example, the magnetic flux emitted from the magnet 103 flows into the magnetic body 102 and flows toward the magnet 104 via the magnetic body 102. As a result, a magnetic circuit is formed by the magnet 103, the magnetic body 102, and the magnet 104 to reduce the divergence of the magnetic flux, the magnetic flux density increases in the region surrounded by the magnet 103, the magnet 104, and the magnetic body 102, and the fluctuation of the magnetic flux density is small even with the magnetic flux density away from the surfaces of the magnet 113 and the magnet 114.

FIG. 7 is a diagram illustrating a waveform of the intensity of the magnetic field applied to the magnetic detection element by the magnetic scale unit of the magnetic encoder according to the first embodiment. The magnetization direction of the magnet 103 is the +z direction, and the magnetization direction of the magnet 104 is the −z direction. In FIG. 7, the vertical axis represents the magnetic flux density Bz, and the horizontal axis represents the position of the magnetic scale unit 101. Note that [a. u.] on the vertical axis and the horizontal axis represents an arbitrary unit. In FIG. 7, a solid line indicates the intensity of the magnetic field applied to the magnetic detection element 107 by the magnetic scale unit 101 of the magnetic encoder 100 according to the first embodiment, and a broken line indicates an ideal sinusoidal waveform. As illustrated in FIG. 7, in the magnetic encoder 100 according to the first embodiment, the waveform of the intensity of the magnetic field applied to the magnetic detection element 107 by the magnetic scale unit 101 is a waveform close to a sine wave.

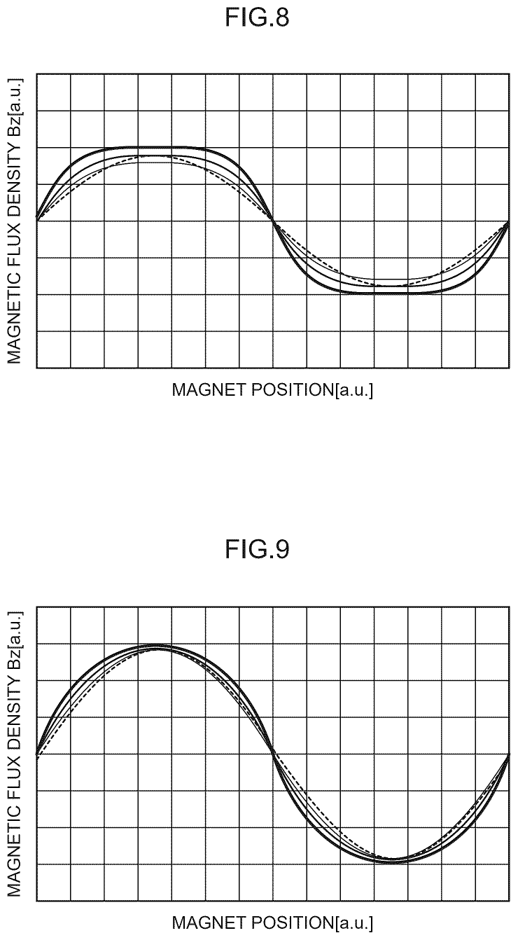

FIG. 8 is a diagram illustrating a waveform of the intensity of the magnetic field applied to the magnetic detection element by the magnetic scale unit when the distance between the magnetic scale and the magnetic detection element of the magnetic encoder according to the comparative example of the first embodiment fluctuates. In FIG. 8, a broken line indicates an ideal sinusoidal waveform. Of three solid lines having different line thicknesses in FIG. 8, a solid line having a middle thickness indicates the intensity of the magnetic field applied to the magnetic detection element 117 by the magnetic scale unit 111. In FIG. 8, a thick solid line indicates the intensity of the magnetic field applied to the magnetic detection element 117 by the magnetic scale unit 111 in the case of the increased distance G from the surface of each of the magnet 113 and the magnet 114 to the sensitive surface of the magnetic detection element 117.

In FIG. 8, a thin solid line indicates the intensity of the magnetic field applied to the magnetic detection element 117 by the magnetic scale unit 111 in the case of the decreased distance G from the surface of each of the magnet 113 and the magnet 114 to the sensitive surface of the magnetic detection element 117. The intensity of the magnetic field applied to the magnetic detection element 117 in the magnetic encoder 110 according to the comparative example of the first embodiment has a large difference from the sine wave of the ideal waveform, regardless of whether the distance G from the surface of each of the magnet 113 and the magnet 114 to the sensitive surface of the magnetic detection element 117 increases or decreases, in a case where the distance between the mover and the stator fluctuates and the distance G changes. As compared to the sine wave, in addition, the waveform of the intensity of the magnetic field applied to the magnetic detection element 117 is in a crushed shape having an amplitude close to the maximum value at a long section of the magnet position. It is therefore difficult to provide an accurate correspondence between the intensity of the magnetic field applied to the magnetic detection element 117 and the magnet position. As a result, the position detection accuracy is decreased.

FIG. 9 is a diagram illustrating a waveform of the intensity of the magnetic field applied to the magnetic detection element by the magnetic scale unit when the distance between the magnetic scale and the magnetic detection element of the magnetic encoder according to the first embodiment fluctuates. In FIG. 9, a broken line indicates an ideal sinusoidal waveform. Of three solid lines having different line thicknesses in FIG. 9, a solid line having a middle thickness indicates the intensity of the magnetic field applied to the magnetic detection element 107 by the magnetic scale unit 101. In FIG. 9, a thick solid line indicates the intensity of the magnetic field applied to the magnetic detection element 107 by the magnetic scale unit 101 in the case of the increased distance G from the surface of each of the magnet 103 and the magnet 104 to the sensitive surface of the magnetic detection element 107. In FIG. 9, a thin solid line indicates the intensity of the magnetic field applied to the magnetic detection element 107 by the magnetic scale unit 101 in the case of the decreased distance G from the surface of each of the magnet 103 and the magnet 104 to the sensitive surface of the magnetic detection element 107. The intensity of the magnetic field applied to the magnetic detection element 107 in the magnetic encoder 100 according to the first embodiment has a small difference from the sine wave of the ideal waveform, regardless of whether the distance G from the surface of each of the magnet 103 and the magnet 104 to the sensitive surface of the magnetic detection element 107 increases or decreases, in a case where the distance between the mover and the stator fluctuates and the distance G changes. In addition, the waveform of the intensity of the magnetic field applied to the magnetic detection element 107 is in a substantially sinusoidal shape. This makes it possible to provide an accurate correspondence between the intensity of the magnetic field applied to the magnetic detection element 107 and the magnet position. As a result, the position detection accuracy can be enhanced.

In order to detect the absolute position of the magnetic scale unit 101, it is necessary to generate a signal having a long period with respect to the stroke of the magnetic scale unit 101. In the magnetic encoder 100 according to the first embodiment, the magnetic body 102 has a convexly curved surface protruding toward the magnet 103 and the magnet 104, and the magnetic scale unit 101 can generate a smooth sine wave signal having a long period with the magnet 103 and the magnet 104. The magnetic body 102 forms a magnetic circuit together with the magnet 103 and the magnet 104. As a result, the absolute position of the magnetic scale unit 101 can be continuously detected in a wide range with high accuracy.

Note that, although the structure in which the magnet 103, the magnet 104, and the magnetic body 102 are disposed at intervals in the y direction has been described here, the magnet 103, the magnet 104, and the magnetic body 102 may be disposed at intervals in the z direction.

### Second Embodiment

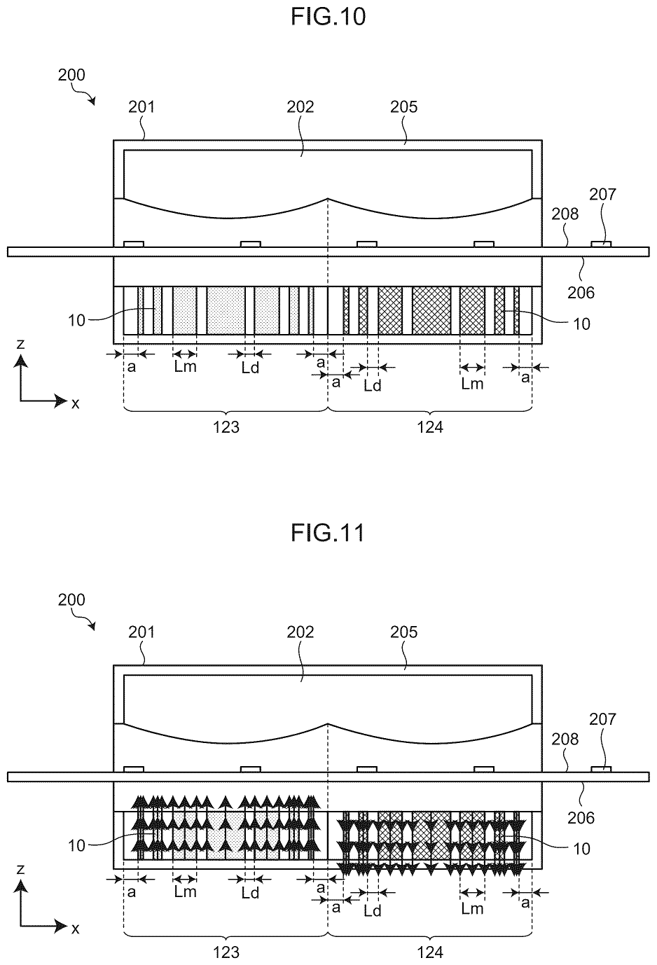

FIG. 10 is a front view illustrating a magnetic encoder according to the second embodiment. The magnetic encoder 200 according to the second embodiment includes a magnet group 123 defined as a first magnetic field generation source and a magnet group 124 defined as a second magnetic field generation source. Each of the magnet group 123 and the magnet group 124 is formed of a plurality of magnets 10. Each of the magnet group 123 and the magnet group 124, and the magnetic body 202 are fixed by a base body 205. The magnetic body 202 has convexly curved surfaces facing the magnet group 123 and the magnet group 124 and protruding toward the magnet group 123 and the magnet group 124. The magnetic body 202 has opposite end portions and a center in the x direction. The opposite end portions and the center provides the maximum intervals between the magnetic body 202 and each of the magnet group 123 and the magnet group 124. In addition, the magnetic body 202 has a position located ¼ times the length Lsm of the magnetic body 202 away from the end portion of the magnetic body 202 in the x direction, and a position located ¾ times Lsm away from the end portion of the magnetic body 202 in the x direction. These positions away from the end portion provide the minimum intervals between the magnetic body 202 and each of the magnet group 123 and the magnet group 124.

FIG. 11 is a diagram illustrating directions of internal magnetization of magnet groups in the magnetic encoder according to the second embodiment. The magnetic encoder 200 according to the second embodiment employs a magnet width modulation scheme that changes the magnet width Lm that is the length of the magnet 10 in the x direction defined as the first direction. Arrows in the magnet group 123 and arrows in the magnet group 124 illustrated in FIG. 11 indicate directions of internal magnetization after magnetization. The distal end of each arrow indicates the N pole, and the proximal end of the arrow indicates the S pole. Thus, all the magnets 10 defining the magnet group 123 have N poles on the side facing the position detection unit 206. All the magnets 10 defining the magnet group 124 have S poles on the side facing the position detection unit 206. The direction of internal magnetization of each magnet 10 is hereinafter simply referred to as a magnetization direction. As described above, all the magnets 10 defining the magnet group 123 are magnetized in the same magnetization direction, and all the magnets 10 defining the magnet group 124 are magnetized in the magnetization direction opposite to the magnetization direction of the magnets 10 defining the magnet group 123.

The number of the magnets 10 defining the magnet group 123 and the number of the magnets 10 defining the magnet group 124 are the same, that is, three or more. In each of the magnet group 123 and the magnet group 124, the interval between magnets 10 is constant. The magnet width Lm increases or decreases according to a sine function which is a sine wave function in the x direction. That is, each of the magnet group 123 and the magnet group 124 has the magnet width Lm increasing from the end portion toward the central portion in the x direction. In other words, each of the magnet group 123 and the magnet group 124 has the magnet width Lm gradually increasing from one end portion to the center in the x direction, and then gradually decreasing from the center to the other end portion in the x direction. On the other hand, the interval Ld between the magnets 10 is constant.

As illustrated in FIG. 10, the number of magnets 10 defining the magnet group 123 is seven. The number of magnets 10 defining the magnet group 124 is also seven. Of the magnets 10 defining the magnet group 123, the magnet 10 installed farthest from the magnet group 124 has its one end portion in the −x direction of the magnet 10, and a position the distance “a” away from the one end portion of the farthest magnet 10 in the −x direction corresponds to 0 degrees of the sine function. Of the magnets 10 defining the magnet group 124, further, the magnet 10 installed farthest from the magnet group 123 has its one end portion in the +x direction, and a position the distance “a” away from the one end portion of the farthest magnet 10 in the tx direction corresponds to 360 degrees of the sine function. Of the magnets 10 defining the magnet group 123, further, the magnet 10 installed closest to the magnet group 124 has its one end portion in the +x direction, and a position the distance “a” away from the one end portion of the closest magnet 10 in the +x direction corresponds to 180 degrees of the sine function. Of the magnets 10 defining the magnet group 124, the magnet 10 installed closest position to the magnet group 123 has its one end portion in the −x direction, and the position corresponding to 180 degrees of the sine function is the distance “a” away from the one end portion of the closest magnet 10 in the −x direction.

The magnets 10 defining the magnet group 123 include the magnet 10 installed farthest from the magnet group 124, and the magnet 10 installed closest to the magnet group 124, the farthest magnet 10 having the one end portion in the −x direction, the closest magnet 10 having the one end portion in the +x direction, the distance “a” being set such that an intermediate position between the one end portion of the farthest magnet 10 of the magnet group 123 and the one end portion of the closest magnet 10 of the magnet group 123 corresponds to 90 degrees of the sine function. The magnets 10 defining the magnet group 124 includes the magnet 10 installed farthest from the magnet group 123, and the magnet 10 closest to the magnet group 123, the farthest magnet 10 having the one end portion in the +x direction, the closest magnet 10 having the one end portion in the-x direction, the distance “a” being set such that an intermediate position between the one end portion of the farthest magnet 10 of the magnet group 124 and the one end portion of the closest magnet 10 of the magnet group 124 corresponds to 270 degrees of the sine function.

The position detection unit 206, which is similar to the position detection unit 106 of the magnetic encoder 100 according to the first embodiment, includes the plurality of magnetic detection elements 207 that detect a magnetic field generated from the magnetic scale unit 201, and the substrate 208 having the magnetic detection elements 207 attached thereto.

The magnetic scale unit 201 and the position detection unit 206 move relative to each other. In the first embodiment, the magnetic scale unit 201 is a mover that moves in the x direction. The position detection unit 206 is a stator fixed at a certain distance from the magnetic scale unit 201 in the z direction. The position detection unit 206 detects the position of the magnetic scale unit 201 from a magnetic field change at the time the magnetic scale unit 201 moves past the position detection unit 206.

The substrate 208 has a band shape having a surface extending in parallel to the xy plane, and the x direction is a longitudinal direction. As illustrated in FIG. 10, the plurality of magnetic detection elements 207 are disposed on the substrate 208 at equal pitches in the x direction. A pitch at which the magnetic detection elements 207 are disposed is set to a pitch equal to or less than a sine wave wavelength formed by the magnetic scale unit 201 so as not to provide a region in which the detection of the position of the magnetic scale unit 201 fails.

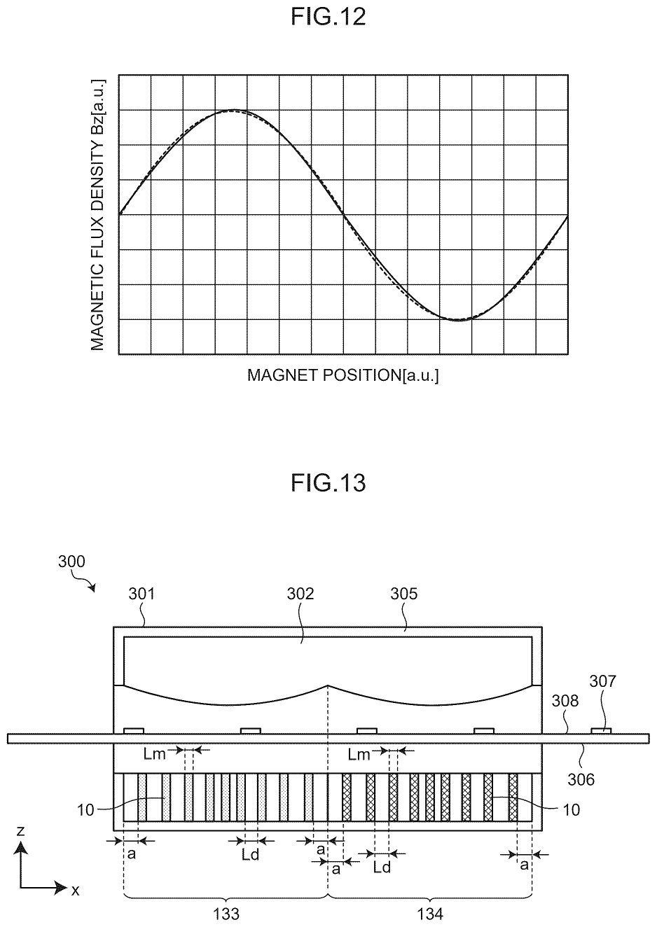

FIG. 12 is a diagram illustrating a waveform of the intensity of the magnetic field applied to the magnetic detection element by the magnetic scale unit of the magnetic encoder according to the second embodiment. In FIG. 12, the vertical axis represents the magnetic flux density Bz, and the horizontal axis represents the position of the magnetic scale unit 201. Note that [a. u.] on the vertical axis and the horizontal axis represents an arbitrary unit. In FIG. 12, a solid line indicates the intensity of the magnetic field applied to the magnetic detection element 207 by the magnetic scale unit 201 of the magnetic encoder 200 according to the second embodiment, and a broken line indicates a sinusoidal waveform which is ideal. As illustrated in FIG. 12, the waveform of the intensity of the magnetic field applied to the magnetic detection element 207 by the magnetic scale unit 201 in the magnetic encoder 200 according to the second embodiment is a waveform close to a sine wave. As compared with the waveform of the intensity of the magnetic field applied to the magnetic detection element 107 by the magnetic scale unit 101 of the magnetic encoder 100 according to the first embodiment illustrated in FIG. 7, the waveform of the intensity of the magnetic field applied to the magnetic detection element 207 by the magnetic scale unit 201 of the magnetic encoder 200 according to the second embodiment is a waveform closer to a sine wave.

Since the waveform of the intensity of the magnetic field applied to the magnetic detection element 207 by the magnetic scale unit 201 of the magnetic encoder 200 according to the second embodiment is closer to a sine wave than the waveform of the intensity of the magnetic field applied to the magnetic detection element 107 by the magnetic scale unit 101 of the magnetic encoder 100 according to the first embodiment, it is possible to further improve the position detection accuracy as compared with the magnetic encoder 100 according to the first embodiment.

Although the second embodiment makes the change in the sinusoidal magnetic field by providing the different magnet widths, the change in the sinusoidal magnetic field may be made by changing the magnetic force of each of the magnets 10 having the same magnet widths. Examples of methods of changing the magnetic force include changing the thickness of the magnet 10 step-by-step, changing the distance from the magnetic detection element 207 step-by-step, changing the magnetization rate of the magnet 10 step-by-step, and changing the magnet material of the magnet 10 step-by-step.

### Third Embodiment

FIG. 13 is a front view illustrating a magnetic encoder according to the third embodiment. The magnetic encoder 300 according to the second embodiment includes a magnet group 133 defined as a first magnetic field generation source and a magnet group 134 defined as a second magnetic field generation source. Each of the magnet group 133 and the magnet group 134 is formed of a plurality of magnets 10. Each of the magnet group 133 and the magnet group 134 and the magnetic body 302 are fixed by a base body 305. The magnetic body 302 has convexly curved surfaces facing the magnet group 133 and the magnet group 134 and protruding toward the magnet group 133 and the magnet group 134. The magnetic body 302 has opposite end portions and a center in the x direction. The opposite end portions and the center provides the maximum intervals between the magnetic body 302 and each of the magnet group 133 and the magnet group 134. In addition, the magnetic body 302 has a position located ¼ times the length Lsm of the magnetic body 302 away from the end portion of the magnetic body 302 in the x direction, and a position located ¾ times Lsm away from the end portion of the magnetic body 302 in the x direction. These positions away from the end portion of the magnetic body 302 provide the minimum intervals between the magnetic body 302 and each of the magnet group 133 and the magnet group 134.

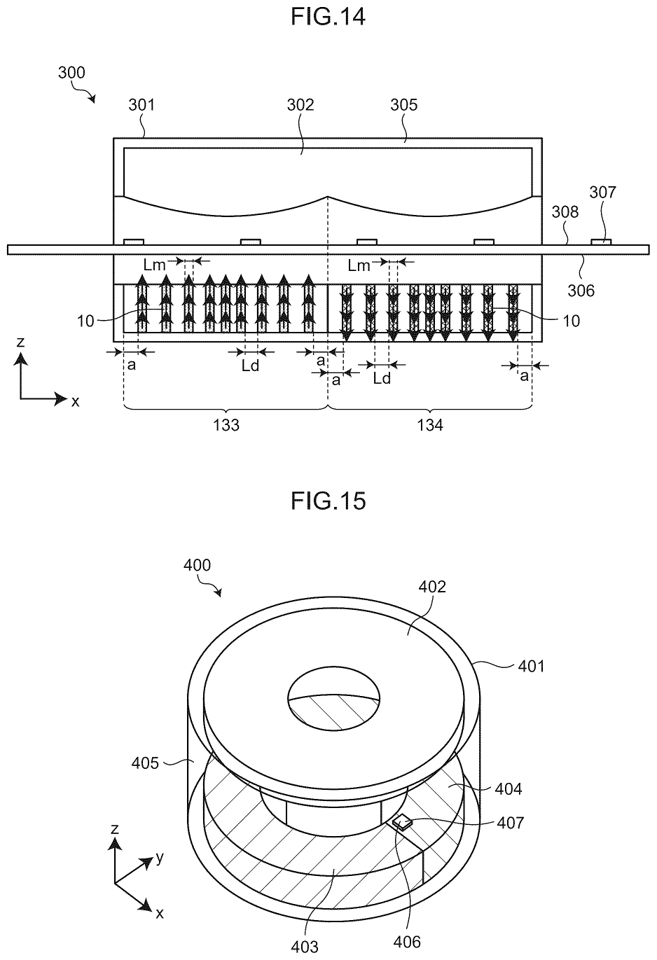

FIG. 14 is a diagram illustrating directions of internal magnetization of magnet groups in the magnetic encoder according to the third embodiment. The magnetic encoder 300 according to the third embodiment employs a magnet interval modulation scheme that changes the interval between the magnets 10. Arrows in the magnet group 133 and arrows in the magnet group 134 illustrated in FIG. 14 indicate directions of internal magnetization after magnetization. The distal end of each arrow indicates the N pole, and the proximal end of the arrow indicates the S pole. Thus, all the magnets 10 defining the magnet group 133 have N poles on the side facing the position detection unit 306. All the magnets 10 defining the magnet group 134 have S poles on the side facing the position detection unit 306. The direction of internal magnetization of each magnet 10 is hereinafter simply referred to as a magnetization direction. As described above, all the magnets 10 defining the magnet group 133 are magnetized in the same magnetization direction, and all the magnets 10 defining the magnet group 134 are magnetized in the magnetization direction opposite to the magnetization direction of the magnets 10 defining the magnet group 133.

The position detection unit 306 includes a plurality of magnetic detection elements 307 that detect a magnetic field generated from the magnetic scale unit 301, and a substrate 308 having the magnetic detection elements 307 attached thereto.

The number of the magnets 10 defining the magnet group 133 and the number of the magnets 10 defining the magnet group 134 are the same, that is, three or more. In each of the magnet group 133 and the magnet group 134, the magnet width Lm is constant. The interval between the magnets 10 increases or decreases according to a sine function which is a sine wave function. That is, the interval Ld between the magnets 10 in each of the magnet group 123 and the magnet group 124 decreases from the end portion toward the central portion in the x direction. In other words, the interval Ld between the magnets 10 in each of the magnet group 133 and the magnet group 134 gradually decreases from one end portion to the center in the x direction, and then gradually increases from the center to the other end portion in the x direction.

As illustrated in FIG. 13, the number of magnets 10 defining the magnet group 133 is nine. The number of magnets 10 defining the magnet group 134 is also nine. Of the magnets 10 defining the magnet group 133, the magnet 10 installed farthest from the magnet group 134 has it one end portion in the −x direction, and a position the distance “a” away from the one end portion of the farthest magnet 10 in the-x direction corresponds to 0 degrees of the sine function. Of the magnets 10 defining the magnet group 134, further, the magnet 10 installed farthest position from the magnet group 133 has its one end portion in the +x direction of the magnet 10, and a position the distance “a” away from the one end portion of the farthest magnet 10 in the +x direction corresponds to 360 degrees of the sine function. Of the magnets 10 defining the magnet group 133, further, the magnet 10 installed closest to the magnet group 134 has its one end portion in the +x direction, and a position the distance “a” away from the one end portion of the closest magnet 10 in the +x direction corresponds to 180 degrees of the sin function. Of the magnets 10 defining the magnet group 134, the magnet 10 installed closest to the magnet group 133 has its one end portion in the −x direction, and the position corresponding to 180 degrees of the sine function is the distance “a” away from the one end portion of the closest magnet 10 in the-x direction.

The magnets 10 defining the magnet group 133 includes the magnet 10 installed farthest from the magnet group 134 and the magnet installed closest to the magnet group 134, the farthest magnet 10 having the one end portion in the-x direction, the closest magnet 10 having the one end portion in the +x direction, the distance “a” being set such that an intermediate position between the one end portion of the farthest magnet 10 and the one end portion of the closest magnet 10 corresponds to 90 degrees of the sine function. The magnets 10 defining the magnet group 134 includes the magnet installed farthest from the magnet group 133, and the magnet 10 installed closest to the magnet group 133, the farthest magnet 10 having the one end portion in the +x direction, the closest magnet having the one end portion in the-x direction, the distance “a” being set such that an intermediate position between the one end portion of the farthest magnet 10 and the one end portion of the closest magnet 10 corresponds to 270 degrees of the sin function.

Similarly to the magnetic encoder 200 according to the second embodiment, the waveform of the intensity of the magnetic field applied to the magnetic detection element 307 by the magnetic scale unit 301 in the magnetic encoder 300 according to the third embodiment is a waveform close to a sine wave, as compared with the waveform of the intensity of the magnetic field applied to the magnetic detection element 107 by the magnetic scale unit 101 of the magnetic encoder 100 according to the first embodiment.

The magnetic encoder 300 according to the third embodiment can thus further improve the position detection accuracy as compared with the magnetic encoder 100 according to the first embodiment.

### Fourth Embodiment

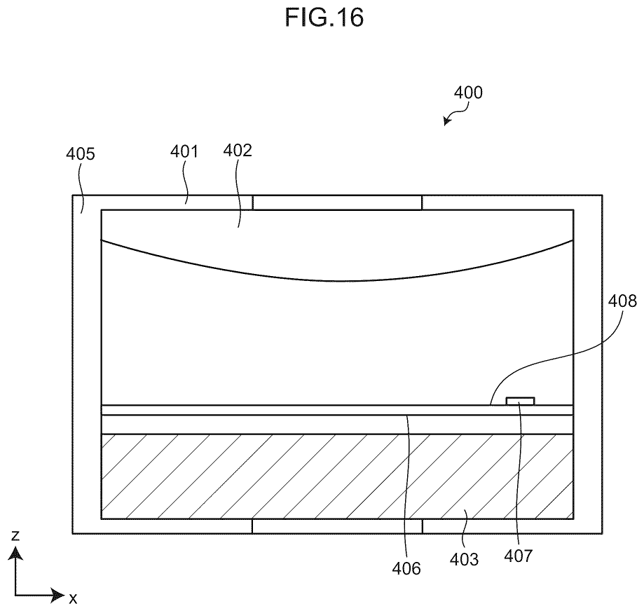

FIG. 15 is a perspective view illustrating a configuration of a magnetic encoder according to the fourth embodiment. FIG. 16 is a front view illustrating a magnetic encoder according to the fourth embodiment. The magnetic encoder 400 of the fourth embodiment is a rotary encoder. The magnetic encoder 400 of the fourth embodiment includes a ring-shaped magnetic scale unit 401 and a position detection unit 406. The position detection unit 406 detects a magnetic field generated from the magnetic scale unit 401. In the fourth embodiment, the magnetic scale unit 401 is a mover, and the position detection unit 406 is a stator.

The magnetic scale unit 401 includes a magnet 403 defined as a first magnetic field generation source, and a magnet 404 defined as a second magnetic field generation source. The magnetic scale unit 401 further includes a magnetic body 402 and a base body 405. The magnetic body 402 is disposed an interval away from each of the magnet 403 and the magnet 404 in the magnetization direction of the magnet 403 and the magnet 404. The base body 405, which is non-magnetic, fixes the magnetic body 402, the magnet 403, and the magnet 404. The magnetic body 402 has a convexly curved surface facing and protruding toward the magnet 403 and the magnet 404. The base body 405 has a cylindrical shape. The magnetic scale unit 401 is installed on a rotating shaft (not illustrated) and rotates. In the present disclosure, in the case of the rotary encoder, the circumferential direction, which is the rotation direction of the magnetic scale unit 401, corresponds to the first direction.

The position detection unit 406 includes a ring-shaped substrate 408 and a magnetic detection element 407. The magnetic detection element 407 is installed on the substrate 408. The magnetic detection element 407 detects a magnetic field generated from the magnetic scale unit 401. The magnetic detection element 407 is fixed on the substrate 408 at a certain distance in the z direction from the magnetic scale unit 401. The position detection unit 406 detects the position of the magnetic scale unit 401 on the basis of a magnetic field change at the time the magnetic scale unit 401 rotates. In FIG. 15, the substrate 408 is not illustrated.

Note that the magnet width modulation scheme described in the second embodiment or the magnet interval modulation scheme described in the third embodiment may be applied to the magnetic encoder 400 according to the fourth embodiment.

In the magnetic encoder 400 according to the fourth embodiment, since the magnetic body 402 forms a magnetic circuit together with the magnet 403 and the magnet 404, the absolute position of the magnetic scale unit 401 can be detected with high accuracy.

The configurations described in the above-mentioned embodiments indicate examples. The configurations can be combined with another well-known technique, and some of the configurations can be omitted or changed in a range not departing from the gist.

### REFERENCE SIGNS LIST

10, 103, 104, 113, 114, 403, 404 magnet; 100, 110, 200, 300, 400 magnetic encoder; 101, 111, 201, 301, 401 magnetic scale unit; 102, 202, 302, 402 magnetic body; 105, 115, 205, 305, 405 base body; 106, 116, 206, 306, 406 position detection unit; 107, 117, 207, 307, 407 magnetic detection element; 108, 118, 208, 308, 408 substrate; 123, 124, 133, 134 magnet group.

1. A magnetic encoder including a magnetic scale unit and a position detection unit, the magnetic scale unit and the position detection unit moving relative to each other along a first direction, wherein
the magnetic scale unit includes:
a first magnetic field generation source and a second magnetic field generation source disposed side by side in the first direction and having magnetization directions opposite to each other;
a magnetic body disposed with an interval away from the first magnetic field generation source and the second magnetic field generation source along a magnetization direction of the first magnetic field generation source and the second magnetic field generation source; and
a base body to position the first magnetic field generation source, the second magnetic field generation source, and the magnetic body, the position detection unit includes:
a magnetic detection element disposed in a region between the magnetic body and each of the first magnetic field generation source and the second magnetic field generation source with an interval between the magnetic detection element and each of the first magnetic field generation source, the second magnetic field generation source, and the magnetic body, and to output a change in magnetic field as an electric signal,
the magnetic body has a length in the first direction, the length being a length corresponding to one wavelength of a wavelength determined on a basis of resolution of position detection of the magnetic scale unit in the first direction, and the magnetic body has a curved surface facing the first magnetic field generation source and the second magnetic field generation source, the magnetic body having an end portion in the first direction and positions corresponding to ¼ and ¾ of the wavelength from the end portion in the first direction, the curved surface being most convex at the positions corresponding to ¼ and ¾ of the wavelength, and
the first magnetic field generation source is disposed at a position facing the position corresponding to ¼ of the wavelength, and the second magnetic field generation source is disposed at a position facing the position corresponding to ¾ of the wavelength.

2. The magnetic encoder according to claim 1, wherein
each of the first magnetic field generation source and the second magnetic field generation source is a magnet group formed of a plurality of magnets having the same magnetization directions,
the magnets of the first magnetic field generation source are disposed at intervals in the first direction,
all the magnets of the first magnetic field generation source are magnetized in the same magnetization direction,
the magnets of the second magnetic field generation source are disposed at intervals in the first direction,
all the magnets of the second magnetic field generation source are magnetized in a magnetization direction opposite to that of the magnets of the first magnetic field generation source, and
magnet widths of the magnets of the first magnetic field generation source and the magnets of the second magnetic field generation source gradually change along the first direction.

3. The magnetic encoder according to claim 1, wherein
each of the first magnetic field generation source and the second magnetic field generation source is a magnet group formed of a plurality of magnets having the same magnetization directions,
the magnets of the first magnetic field generation source are disposed at intervals in the first direction,
all the magnets of the first magnetic field generation source are magnetized in the same magnetization direction,
the magnets of the second magnetic field generation source are disposed at intervals in the first direction,
all the magnets of the second magnetic field generation source are magnetized in a magnetization direction opposite to that of the magnets of the first magnetic field generation source, and
an interval between the magnets of the first magnetic field generation source and an interval between the magnets of the second magnetic field generation source gradually change along the first direction.

4. The magnetic encoder according to claim 1, wherein
the position detection unit is disposed on a stator, and the magnetic scale unit is disposed on a mover, and
the magnetic detection element includes a plurality of magnetic detection elements installed along the first direction.

5. The magnetic encoder according to claim 1, wherein the magnetic encoder is a linear encoder.

6. The magnetic encoder according to claim 1, wherein the magnetic encoder is a rotary encoder.

7. The magnetic encoder according to claim 2, wherein
the position detection unit is disposed on a stator, and the magnetic scale unit is disposed on a mover, and
the magnetic detection element includes a plurality of magnetic detection elements installed along the first direction.

8. The magnetic encoder according to claim 3, wherein
the position detection unit is disposed on a stator, and the magnetic scale unit is disposed on a mover, and
the magnetic detection element includes a plurality of magnetic detection elements installed along the first direction.

9. The magnetic encoder according to claim 2, wherein the magnetic encoder is a linear encoder.

10. The magnetic encoder according to claim 3, wherein the magnetic encoder is a linear encoder.

11. The magnetic encoder according to claim 4, wherein the magnetic encoder is a linear encoder.

12. The magnetic encoder according to claim 7, wherein the magnetic encoder is a linear encoder.

13. The magnetic encoder according to claim 8, wherein the magnetic encoder is a linear encoder.

14. The magnetic encoder according to claim 2, wherein the magnetic encoder is a rotary encoder.

15. The magnetic encoder according to claim 3, wherein the magnetic encoder is a rotary encoder.

16. The magnetic encoder according to claim 4, wherein the magnetic encoder is a rotary encoder.

17. The magnetic encoder according to claim 7, wherein the magnetic encoder is a rotary encoder.

18. The magnetic encoder according to claim 8, wherein the magnetic encoder is a rotary encoder.
